(19) United States
(12) Patent Application Publication
(10) Pub. No.: US 2020/0200918 A1
(43) Pub. Date: Jun. 25, 2020

(54) Asset Tracking System

(71) Applicant: Optimal Design Co., Arlington Heights, IL (US)

(72) Inventors: Joseph Z. Wascow, Vernon Hills, IL (US); Michael Ottoman, Wauconda, IL (US); Joseph Kreidler, Arlington Heights, IL (US); Walter W. Sloan, Lake Bluff, IL (US); Dwayne D. Forsyth, Deer Park, IL (US); Andrew Renn, Round Lake, IL (US); Andrew Orosz, Arlington Heights, IL (US); Ronald Llanes, Lisle, IL (US); Peter Nanni, Algonquin, IL (US)

(21) Appl. No.: 16/708,824

(22) Filed: Dec. 10, 2019

Related U.S. Application Data
(60) Provisional application No. 62/783,890, filed on Dec. 21, 2018.

(51) Int. Cl. G01S 19/41; G06Q 10/08; G01C 21/34; B60R 16/03

(52) U.S. Cl. CPC G01S 19/41; B60R 16/03; G01C 21/3407; G06Q 10/087

(57) ABSTRACT

An asset monitoring device and system may be used to determine and report location and operational status of an asset within a local area network.

### RELATED APPLICATION

The present disclosure claims the filing priority of U.S. Provisional Application No. 62/783,890, titled “OptimalTrax Asset Tracking System,” and filed on Dec. 21, 2018. The '890 Provisional Application is hereby incorporated by reference.

### TECHNICAL FIELD OF THE INVENTION

The present invention relates to asset tracking systems. More specifically, the invention relates to vehicle tracking for inventory and other related purposes.

### BACKGROUND OF THE INVENTION

Car dealerships do not always know the exact location or health of their many vehicles in inventory at any given time. Many of the large dealerships have overflow lots where excess inventory is kept, and these cars are constantly being moved about for various reasons, such as to accommodate new inventory, sales, test drives, maintenance, etc. This makes merely counting and locating vehicles an extremely difficult task.

Unfortunately, for tax and other purposes, having an exact count of vehicles in the dealership inventory is critical. Further, being able to provide real time diagnostic information on any vehicle could speed routine maintenance and knowing the exact description and location for each vehicle by merely accessing a secure private network would also be extremely beneficial in sales.

Until the invention of the present application, these and other problems in the prior art went either unnoticed or unsolved by those skilled in the art. The present invention provides a portable, detachable module which performs multiple functions with an associated network without sacrificing reliability, design, style, security or affordability.

### SUMMARY OF THE INVENTION

There is disclosed herein an improved asset tracking system which avoids the disadvantages of prior systems and devices while affording additional structural and operating advantages.

The disclosed system is for tracking and monitoring vehicles in a local area on a private wireless network. The system is comprised of three primary components: a central network component, called a gateway, bridging a connection between a local area private network and the Internet or cloud, a cloud-based platform, and a vehicle status and location tracking device in each vehicle.

The gateway (or multiple gateways for larger areas) establishes a private local area network using radio technology which could be LoRa (Long-Range) or a similar local network technology.

The status and location tracking devices in the vehicles can join the local network to send and receive messages with the gateway. The data in messages may contain information, such as vehicle error codes, car battery voltage, fuel level, vehicle GPS coordinates, or any other vehicle or network status information. The vehicle devices can be connected to a vehicle via the vehicle's OBD port, via an accessory power port, or may be left unconnected in a vehicle to just track the vehicle's location. The devices in the vehicles may also wirelessly communicate with each other and relay messages from one another back to the gateway.

The vehicle devices may contain an array of sensors to gather information about the vehicles in which they are operating, such as automotive CANbus monitoring devices to interact directly with and query vehicle electronics, analog-to-digital converters for measuring vehicle parameters like battery voltage, GPS location devices, temperature or thermal sensors, accelerometers, cameras, microphones, and more. Any data gathered by the vehicle devices may be transmitted over the local area network.

By communicating with each other, the vehicle devices may be able to allow determination of a relative location from each other to form a map of the locations of all the vehicles without requiring the use of GPS.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a general illustration of an embodiment of the disclosed asset tracking system:

FIG. 2 is a perspective view of an embodiment of a vehicle device in accordance with the present disclosure;

FIG. 3 illustrates a typical OBD-II port and pinning diagram;

FIG. 4 is a diagram of an embodiment of a battery charging feature for the disclosed vehicle device;

FIG. 5 is a diagram illustrating various potential features of an embodiment of the device of FIG. 2;

FIG. 6 is a diagram illustrating a dynamic beaconing feature of the disclosed system;

FIG. 7 is a flow chart illustrating an embodiment of the dynamic beaconing feature of the disclosed system;

FIG. 8 is a flow chart illustrating an embodiment of the process for receiving a New Vehicle to inventory for the disclosed system;

FIG. 9 is a flow chart illustrating an embodiment of the New Vehicle Battery Warranty Alert timer process; and

FIGS. 10 and 11 collectively illustrate an operational logic for an embodiment of the disclosed system.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

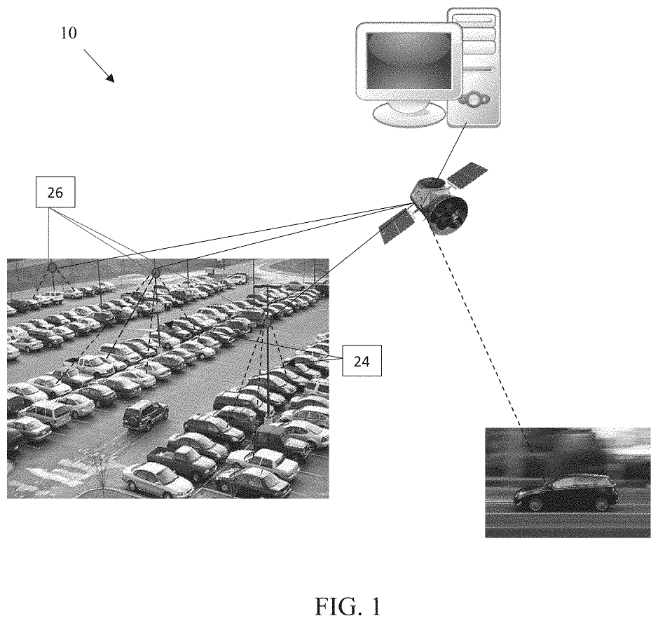

Referring to FIGS. 1-11, there is illustrated an asset tracking system (ATS), generally indicated by the reference number 10, including its several components and numerous illustrations of functionalities. A particular embodiment of ATS 10 is generally illustrated in FIG. 1. The ATS 10 is for tracking assets, such as an automobile inventory at, e.g., a sales facility. However, while all the embodiments illustrated are directed for use with vehicles, such as cars, it should be understood that the principles of the invention can be more broadly applied to include trucks, boats, motorcycles, buses, earthmovers, heavy machinery, watercraft and even planes. Accordingly, the term “vehicle” as used herein is intended to cover all such uses and drivable equipment.

Generally speaking, the Automotive Asset Tracking System (ATS) 10 tracks the location and monitors a status of vehicles in an inventory (FIG. 1). The ATS 10 can monitor operational parameters and statuses, such as battery voltage, ignition status, fuel, diagnostic trouble codes (“DTCs” or “Fault Codes”), and other vehicle statuses. In an automotive embodiment, the ATS 10 uses a tracking device (“Tracker”) 12 connected to a vehicle's ODB-II port 14 (see FIG. 3). The Tracker 12 includes electronics and software (microcontroller 16) for receiving GPS satellite transmissions, sending and receiving Bluetooth Low Energy (BLE) transmissions, reading DTCs and other vehicle status notifications from a vehicle's electronic control unit (ECU), and transmitting information, such as GPS location coordinates and vehicle status, to an ATS Gateway device 20, which then forwards the Tracker 12 data transmission to the ATS Software as a Service (“SaaS”) platform 22 for storage and processing of vehicle data.

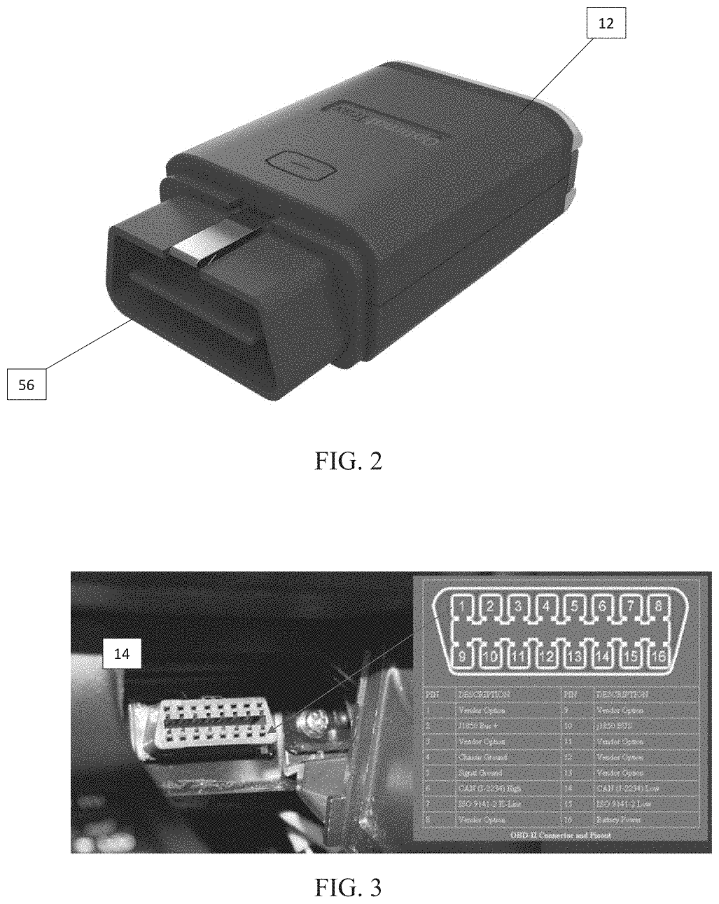

A preferred embodiment of the disclosed system 10 is for tracking and monitoring vehicles in a local area on a private wireless network 24. The system 10 is composed of two primary components: a central network component, called a gateway 26, bridging a connection between a local area private network 24 and the internet or cloud, and a vehicle status and location tracking device—i.e., Tracker 12 (see FIG. 2)—in each vehicle. The gateway 26 (or multiple gateways for larger areas) establishes the private local area network using radio technology which is preferably long-range (LoRa) or a similar local network technology. Each of the devices 12 in a vehicle can join the local network to send and receive messages with the gateway 26. The data contained in messages may include information, such as vehicle error codes, car battery voltage, vehicle GPS coordinates, or any other vehicle or network status information. The vehicle devices 12 are preferably connected to a vehicle via the vehicle's OBD port 14 (see FIG. 3). Alternatively, it may connect via an accessory power port or may be left unconnected in a vehicle to just track the vehicle's location.

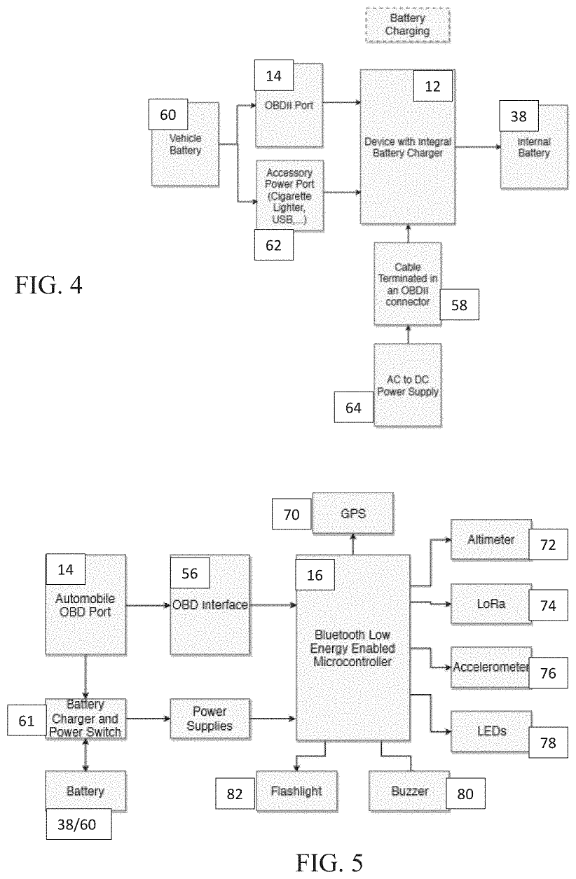

As indicated by the schematic of FIG. 5, the vehicle device 12 includes a BLE microcontroller 16 connected to at least one of a GPS 70, altimeter 72, LoRa 74, accelerometer 76, LEDs 78, annunciator (e.g., buzzer) 80, and a flashlight 82, housed within the device 12. The device 12 also includes a battery 38 and a battery charger 61, which may be charged either via the vehicle OBD port 14 through the OBD interface 56 or via an accessory cable 58 (FIG. 4). The accessory cable 58 could be connected to the automobile's cigarette lighter port or similar automotive port, such as a USB port, or alternatively to a cable terminated in an OBD-II connector, which at the other end is connected to a DC power supply 64. Prior devices which have been used to monitor the status or location of a car have not contained a battery for operation when either (a) the car battery is too low to be used, or (b) the vehicle does not have an accessible OBD-II port.

As to the latter situation, cars prior to 1996 were not required to have an OBD-II port. For these vehicles, the disclosed vehicle device 12 can still be used to track a car location, and the internal battery 38 could still be charged via an accessory cable. Also, when the vehicle tracker 12 is not being used or is being stored, the device 12 can be charged using a DC power supply along with a DC power-connected OBD-II accessory cable. Another power option for charging could be solar power as well. An embodiment of different battery charging options is depicted by the schematic of FIG. 4.

An important feature that is enabled by the presence of a battery 38 in the device 12 is an ability to send a message after the device is unplugged. Such a message may include an alert, a text or an email sent to identified users or security personnel warning them of tampering of the vehicle.

Another key feature of the disclosed device 12 is the ability to run off the vehicle battery 60 as well as its own internal battery 38. Once plugged into a vehicle, the device 12 checks the vehicle battery level. If good, the device 12 will charge itself and run exclusively from the vehicle battery. The device will continue to monitor the battery level and once a threshold is reached (e.g., a point below which the vehicle will be unable to start), the device 12 will switch over to the internal battery 38. It could run for weeks or even months off this internal battery, depending on power requirements.

Once connected to a vehicle, a device 12 may also wirelessly communicate with other devices 12 and relay messages from one another back to the gateway 26. Each vehicle device 12 may contain an array of sensors to gather information about the vehicles in which they are operating, such as automotive CANbus monitoring devices to interact directly with and query vehicle electronics, analog-to-digital converters for measuring vehicle parameters like battery voltage, GPS location devices, temperature or thermal sensors, cameras, accelerometers, microphones, and more. Any data gathered by the vehicle device 12 may be transmitted over the local area network 24.

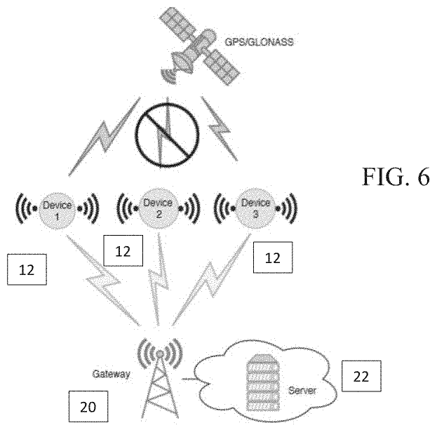

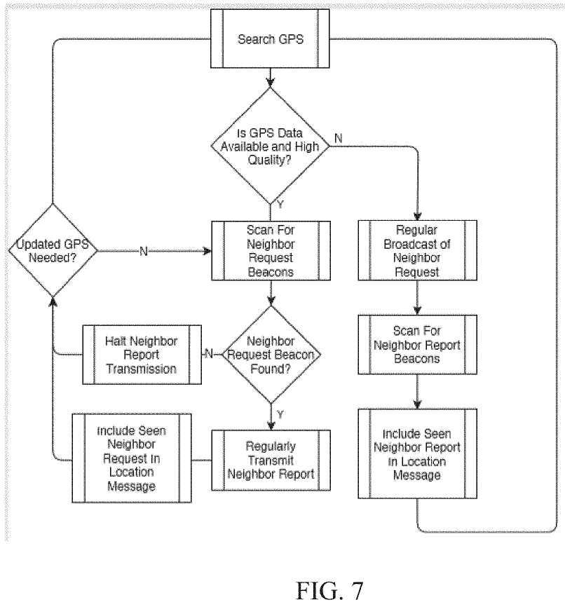

Further, by communicating with each other, the vehicle devices 12 may be able to determine a relative location from each other by forming a map of the locations of all the vehicles. This feature is available without requiring the continuous use of GPS (see FIG. 6 and FIG. 7), though an initial GPS location for each vehicle or the gateway may be required. Accordingly, vehicle devices 12 contain intelligence with the capability to determine their own reporting schedules based on context.

For example, if a vehicle device 12 detects movement, it may begin reporting data at a higher frequency. The vehicle device 12 can also log data while outside of the range of the local network, caching time-stamped data, which can then be transmitted when the vehicle device 12 comes back within range of the local network 24. In areas where reception of the local area network may be poor, vehicle devices 12 can interact with one another and, in coordination, build a map of their relative locations and establish absolute positioning relative to the local area network gateway 26. This feature allows, for example, dealerships to confirm a vehicle is in inventory even when a GPS signal for that vehicle is lost.

As illustrated in FIG. 6, one or more vehicle devices 12 may not contain GPS capabilities, or such capabilities are blocked, disabled or otherwise not working (center device 12). The devices 12 could then rely entirely on building a map of their collective locations by interacting with each other and gateways 26 on the same network. Similarly, if a device 12 does not have a LoRa connection, it can utilize BlueTooth to “talk” to a neighboring vehicle within range to pass along its data. The receiving vehicle can then upload the transmitted data to the cloud via its LoRa connection.

A location augmentation and supplementation system for power-constrained devices is also a feature of the disclosed system 10. Location is usually determined purely with either a satellite navigation-based system or a beaconing system with regular transmissions of the determined position to the network. The processes of acquiring a GPS position and transmitting a determined location are costly from a power consumption standpoint and, as a result, are prone to potential failures in data acquisition and transmission. To overcome these issues, devices 12 periodically communicate with each other via simple BLE to advertise information such as GPS status (e.g., have they acquired GPS coordinates), condensed GPS position, last network report, and the like. Each device 12 will then algorithmically determine a reduced rate of GPS acquisition and reporting that will ensure accurate and timely reporting of device location to the network 24.

The private local network 24 is another key feature of the disclosed system 10. There are cellular connected devices that communicate on public networks and there are devices that communicate locally on a one-to-one basis, e.g., device to a mobile phone. The disclosed system 10 includes a plurality of devices 12 communicating with one another on a network. Further, even out of the network, devices are logging data and uploading the data when they return to the network.

In another preferred embodiment, the vehicle device 12 contains a flashlight 82 (see FIG. 5) to assist the user with inserting the device 12 in a dark vehicle footwell where the OBD-II port 14 is typically located. The device 12 may include a button that activates an LED to provide illumination for the user during the installation process.

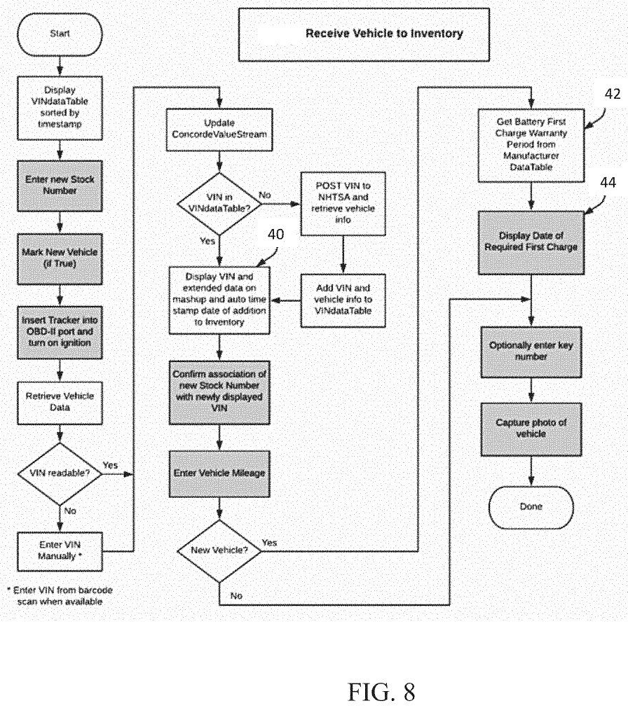

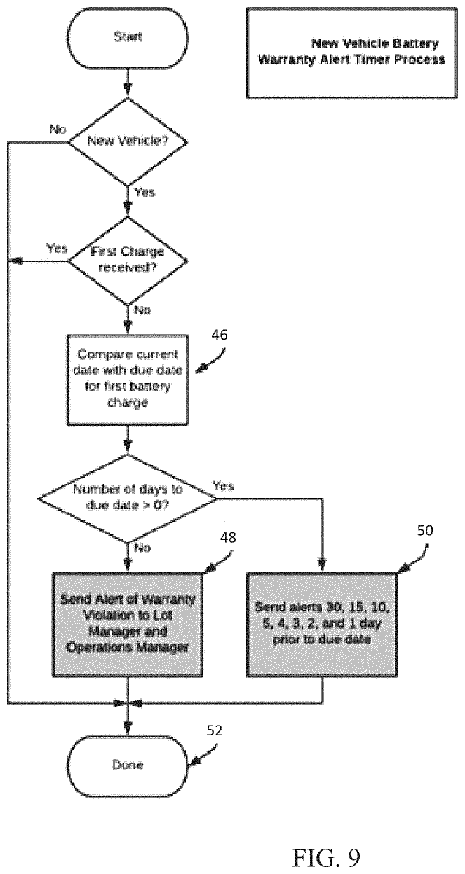

Another important feature of the disclosed invention relates to vehicle activation and maintenance, such as battery warranty alerts. With reference to FIGS. 8 and 9, when a new vehicle is delivered to a dealership, there are requirements placed on the dealership by the manufacturer in order to maintain warranties (i.e., “New Vehicle Activation” protocol). For example, in some cases the manufacturer requires that the vehicle's battery must receive its first charge within a specified period of time after the vehicle is received into dealership inventory, often known as a “First Charge Requirement”. This time period can vary by manufacturer and by vehicle class. If the first battery charge does not occur within the specified number of days to meet the First Charge Requirement, the vehicle cannot be sold under a manufacturer's warranty until the battery is replaced. Battery replacement, to restore the manufacturer's warranty, can cost a dealership hundreds of dollars. The purpose of the New Vehicle Warranty Alert System is to avoid such battery warranty violations. Similarly, the purpose of “New Vehicle Activation” protocols is to maintain manufacturer warranties.

The process of receiving a vehicle into dealership is shown in FIG. 8. In box 40, the time and date of entry of the vehicle into dealership inventory is recorded. If the vehicle is new, then in box 42 the First Charge Requirement is used, along with the date of entry of the new vehicle into dealership inventory, to calculate and display the date in box 44 by which the new vehicle's battery must receive its first charge.

The New Vehicle Battery Warranty Alert Timer Process is shown in FIG. 9. In box 46, the number of days between the current date and the required date for First Charge is calculated. If the number of days to the due date is zero or less (past due), then in box 48 an Alert notification for the battery warranty violation is sent to dealership management. If the number of days to the First Charge due date is greater than zero, then in box 50 notification Alerts are sent out at 30 days, 15 days, 10 days, 5 days, 4 days, 3 days, 2 days and 1 day prior to the due date. The Battery Warranty Alert process is repeated, as required, until the First Charge is received and the process is complete at box 52.

### Operation Example

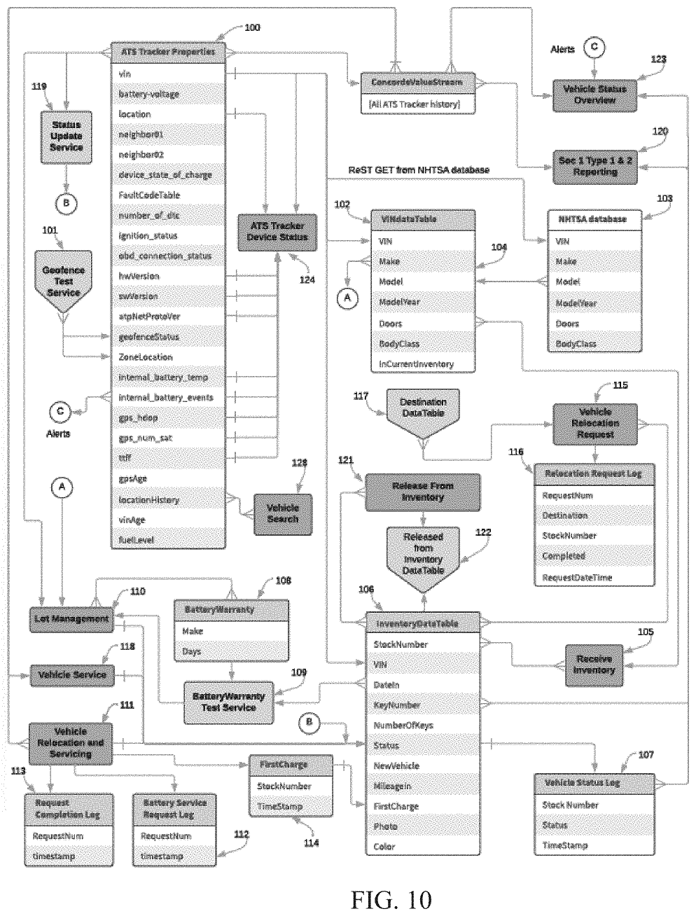

In FIG. 10, ATS Tracker 12 is inserted into OBD-II port 16 of a vehicle (see FIGS. 2 and 3) and the vehicle's ignition is turned on. Properties listed in box 100 are captured from the vehicle, with the exception of geofenceStatus and ZoneLocation, which are generated by Geofence Test Service 101. These properties are time-stamped and captured in the time-series database 102. The VIN captured in box 100 is transmitted to the database 103 and additional vehicle information retrieved from database 103 is captured in database 104. The data in database 104 is displayed in “Receive Inventory” user application 105, which allows for the input of additional vehicle information, examples of which are shown, but not limited to those properties in database 106. Changes to vehicle status in database 106 are logged to time-series database 107.

Vehicle Status in 106 may be one of several categories, including but not limited to the following:
0. Not Reporting
1. Available
2. In Receiving
3. In Service
4. In Transit
5. Sales Demo
6. Test Drive
7. Sold
8. Traded
9. Auction
10. Scrapped
11. Request Pending
12. In Prep
13. Body Shop

Once the “Receive Inventory” user application 105 has been used to complete the logging of a vehicle into database 106, the vehicle's initial Status is set to “2”—i.e., “In Receiving.”

When a vehicle received into inventory is a new vehicle, the NewVehicle Boolean property in database 106 is set to “true.” A new vehicle requires that its battery receive its first charge within a specified number of days. The maximum number of days for a first charge, counted from the day of receipt of the new vehicle into inventory, varies by the manufacturer (“Make”) of the vehicle and is stored in database 108 as “Days.” The default value of FirstCharge in database 106 is “false,” indicating that the battery of a new vehicle has not yet received its first charge. When a new vehicle's battery receives a first charge, FirstCharge in database 106 is set to “true.” If NewVehicle in database 106 is “false,” then FirstCharge in database 106 has no meaning and is not used.

Battery Warranty Service 109 compares the date of receipt of the vehicle into inventory (“TimeStamp” in database 106) with the current date. It uses this difference to generate an Alert in the “Lot Management” user application 110 and posts a due date for charge of a new vehicle's battery. The Alert occurs at specific intervals of days (e.g. 15, 10, 5, 4, 3, 2, and 1) prior to the due date for the required first battery charge.

To request the charging of a vehicle's battery, “Lot Management” user application 110 sends a request to the “Vehicle Relocation and Servicing” user application 111, which logs the Battery Service Request to database 112. Upon completion of the new vehicle's first battery charge, the Vehicle Relocation and Servicing user application 111 updates the “Request Completion Log” database 113, updates the FirstCharge database 114 by adding the StockNumber of the new vehicle and a TimeStamp for the completion of the charge, and updates FirstCharge in 106 to “true.” The change of Status of the new vehicle is logged to “Vehicle Status Log” database 107. Lot Management user application 110 also receives Alerts generated by certain changes of state to ATS Tracker Properties, including but not limited to vehicle movement after hours, geofence violations, low battery conditions, and changes in fault code status.

“Vehicle Relocation” user application 115 is used to request the movement of a vehicle from one location to another, such as from a Remote Lot to the Sales Department. Valid vehicle destinations are obtained from database 117. A vehicle relocation request is logged in database 115 to the Relocation Request Log database 116. The vehicle relocation request is sent to Vehicle Relocation and Servicing user application 111. Upon completion of the vehicle relocation, Vehicle Relocation and Servicing user application 111 updates Request Completion Log database 113.

“Vehicle Service” user application 118 provides information to determine which vehicles require servicing, based on Fault Codes retrieved from ATS Tracker Properties 100. A request for vehicle relocation to the Service Department is initiated using Vehicle Relocation Request user application 115. The request is logged in Relocation Request Log database 116 and sent to Vehicle Relocation and Servicing App 111, which updates the vehicle status in Vehicle Status Log database 107 to “11”, indicating “Relocation Pending.” Upon vehicle Status “Relocation Requested” and detecting movement of the vehicle per data received from ATS Tracker Properties 100, Status Update Service 119 updates the vehicle's Status in database 106 to “In Transit,” and logs the change to Vehicle Status Log database 107.

When servicing of a vehicle is complete, Vehicle Request Relocation user application 115 requests transfer of the vehicle from the Service Department to another location. Upon receipt of the request by the Vehicle Relocation and Servicing user application 111, the vehicle Status in Inventory database 106 is set to “Request Pending” and the Status change is logged to Vehicle Status Log database 107. Upon completing the transfer of the vehicle to the requested destination, the vehicle's Status in the Inventory database 106 and Vehicle Status Log database 107 is updated by the Vehicle Relocation and Servicing App and confirmed by GPS and/or BLE location. The new vehicle status will be either (1) “Available”, (5) “Sales Demo”, (6) “Test Drive”, or (12) “Prep.”

The “SOC 1 Type 1 & 2 Report” user application 120 queries data from time-series database 102, along with vehicle data from databases 106 and 107. The data is then used to generate reports on vehicle inventory status. The status is either determined at a single point in time (Type 1 compliant) or over a period of time (Type 2 compliant).

The “Release From Inventory” user application 121 accesses vehicle data from Inventory database 106 and updates vehicle Status in ReleasedFromInventory database 122 and Vehicle Status Log database 107.

The “Vehicle Status Overview Mashup” 123 queries data from time series database 102, along with vehicle data from databases 106 and 107. This data is used to present an overview of the status of operations, including GPS mapping of queried vehicles. It also receives Alerts generated by certain changes of state to ATS Tracker Properties 100, including but not limited to vehicle movement after hours, geofence violations, low battery conditions, and changes in fault code status.

The “ATS Tracker Device Status” user application 124 tracks the status of ATS Tracker devices 12 and generates alerts when properties cross defined limits.

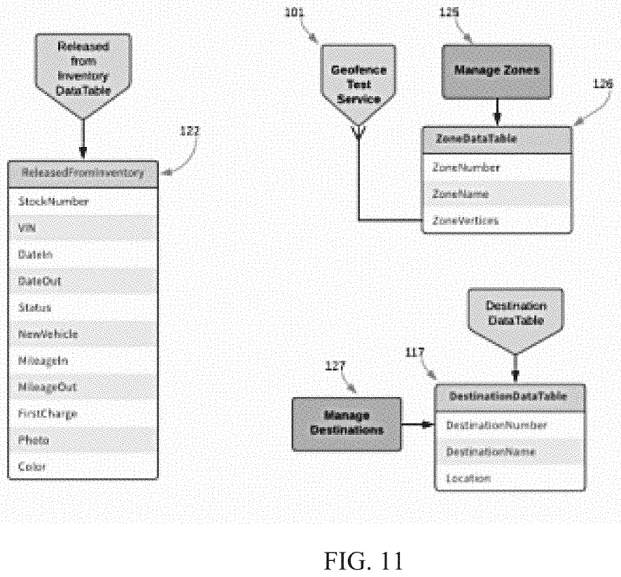

In FIG. 11, Manage Zones user application 125 creates, reads, updates and deletes the Zones that are used for geofencing. ZoneDataTable 126 contains Zones names and GPS locations that define the vertices of the polygon that defines the Zone.

Manage Destinations user application 127 creates, reads, updates and deletes the Destinations in DeatinationDataTable 117 that are used by VehicleRelocationRequest user application 115 in FIG. 10. DestinationDataTable 117 contains DestinationNames and Locations. These Locations are used to confirm the completion of vehicle delivery and the update by the Vehicle Relocation Request user application 115 in FIG. 10 of the Relocation Request Log 116 in FIG. 10.

Vehicle Search user application 128 is used to locate a vehicle by a complete or partial search on a VIN, querying all ATS Tracker Properties 100.

The ReleasedFromInventory database 122 is updated by Release From Inventory user application 121 in FIG. 10. Upon release from inventory of a vehicle, the vehicle's Stock Number, VIN, TimeStampIN, NewVehicle, FirstCharge, Photo, and Color properties are copied to ReleasedFromInventory database 122. The release of the vehicle is timestamped, the Mileage Out is captured, and the Status is updated to either (7) “Sold,” (8) “Traded,” (9) “Auction,” or (10) “Scrapped.”

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. An asset monitoring system comprising:
an asset monitoring device comprising:
a body portion housing a microcontroller, a long-range, low-power, wide-area transceiver, which provides communication capabilities, and at least one of the following components coupled to the microcontroller within the body portion to generate data:
a GPS receiver, which determines location information of the asset monitoring device;
an altimeter, which measures altitude information of the asset monitoring device; and
an accelerometer, which determines motion of the asset monitoring device;
an asset connector configured to be connected to a port on the asset;
an interface within the asset connector coupling the microcontroller to a power source in the asset when connected through the port;
an internet connected gateway; and
an electronic device having a display and connectable to the gateway;
wherein, the microcontroller in the asset monitoring device is configured to collect the data generated by the at least one component in the asset monitoring device and communicate with the gateway, and the electronic device records and displays the data.

2. The asset monitoring system of claim 1, wherein the device is connected to the gateway via LoRa or a similar radio technology.

3. The asset monitoring system of claim 1, wherein the gateway is connected to the Internet via a local area network technology, Cellular or any other means of connecting to the network.

4. The asset monitoring system of claim 1, wherein the asset device further comprises:
an annunciator;
a light source; and
an internal rechargeable power source, which provides power to the microcontroller and other components.

5. The asset monitoring system of claim 4, wherein the internal power source is a rechargeable battery.

6. The asset monitoring system of claim 1, wherein the asset is a vehicle.

7. The asset monitoring system of claim 5, wherein the asset device is configured to alternately draw power from a vehicle battery and the internal battery of the asset device and is able to switch between the two power sources.

8. The asset monitoring system of claim 7, further comprising a vehicle battery monitoring sensor connected to the microprocessor to determine when to run off the vehicle battery and when to run off the internal battery.

9. The asset monitoring system of claim 1, further comprising a new vehicle battery algorithm stored in one of either the gateway, the electronic device or the asset device for setting a battery first service deadline.

10. The asset monitoring system of claim 1, wherein the asset port is an OBD-II port.

11. The asset monitoring system of claim 1, further comprising a plurality of asset monitoring devices.

12. The asset monitoring system of claim 1, wherein the asset monitoring device further comprises short-range wireless communications for communicating with beacons, such as short-range Bluetooth beacons.

13. The asset monitoring system of claim 11, wherein each of the plurality of asset monitoring devices communicates with each other to form a network.

14. An asset monitoring device for connecting to a vehicle, the device comprising:
a body portion housing a microcontroller, a long range, low power, wide area transceiver, which provides communication capabilities, and at least one of the following components coupled to the microcontroller within the body portion to generate data:
a GPS receiver, which determines location information of the asset monitoring device,
an altimeter, which measures altitude information of the asset monitoring device; and
an accelerometer, which determines motion of the asset monitoring device;
a connector configured to be connected to a port on the asset; and
an interface within the connector coupling the microcontroller to a power source in the asset when connected through the port.

15. The asset monitoring device of claim 12, wherein the connector is configured to be inserted into an OBD-II port.

16. The asset monitoring device of claim 12, further comprises:
an annunciator;
a light source; and
an internal rechargeable power source, which provides power to the microcontroller and other components.

17. The asset monitoring device of claim 14, wherein the internal power source is a rechargeable battery.

18. The asset monitoring device of claim 14, wherein the device is configured to alternately draw power from a vehicle battery and the internal battery of the asset device and is able to switch between the two power sources.

19. The asset monitoring device of claim 16, further comprising a vehicle battery monitoring sensor connected to the microprocessor to determine when to run off the vehicle battery and when to run off the internal battery.

20. The asset monitoring device of claim 12, further comprising a new vehicle battery algorithm stored to run on the microcontroller to set a vehicle battery first service deadline.

21. The asset monitoring device of claim 14, further comprising short-range wireless communications for communicating with beacons, such as short-range Bluetooth beacons.
